(19) United States
(12) Patent Application Publication
(10) Pub. No.: US 2026/0090939 A1
(43) Pub. Date: Apr. 2, 2026

(54) Emergency system for patient lifts and method thereof

(71) Applicant: SAVARIA CONCORD LIFTS INC., Brampton (CA)

(72) Inventors: Mathieu Beaupre, Sherbrooke (CA); Michel Corriveau, Saint-Denis-de-Brompton (CA); Stephane Lebrun, Sherbrooke (CA); Jonathan Benoit, Sherbrooke (CA); Mathew Howitt, Magog (CA); Marc-Andre Gervais, Sherbrooke (CA)

(21) Appl. No.: 19/341,181

(22) Filed: Sep. 26, 2025

Related U.S. Application Data
(60) Provisional application No. 63/700,210, filed on Sep. 27, 2024.

(51) Int. Cl. A61G 7/10

(52) U.S. Cl. CPC A61G 7/1065

(57) ABSTRACT

An emergency system for patient lifts is provided. The emergency system immediately halts the operation of the lift operation in emergency situations, such failure. The system comprises an inner body portion slidably inserted in an outer portion. In use, when an emergency occurs, a user pulls on the outer portion which slides in relation to the inner portion. The sliding triggers the stopping the motor of the patient lift. When the outer portion is slid over the inner portion, an interface to the motor or the patient lift may be revealed.

### CROSS-REFERENCE TO RELATED APPLICATIONS

The present patent application claims the benefits of priority of U.S. Provisional Patent Application No. 63/700,210, entitled “EMERGENCY SYSTEM FOR PATIENT LIFTS AND METHOD THEREOF”, and filed at the United States Patent and Trademark Office on Sep. 27, 2025, the content of which is incorporated herein by reference.

### FIELD OF THE INVENTION

The present invention generally relates to security devices and system for patient lifts and to methods for managing emergencies in relation with a patient lift system. More particularly, the present invention relates to an emergency system and methods adapted to halt and moving patient lifts during emergency situations or patient lift failures to ensure patient safety and ease of operation for caregivers.

### BACKGROUND OF THE INVENTION

Ceiling-mounted overhead patient lift systems typically function as winches and are commonly equipped with a housing or frame secured to a ceiling rail. Such systems typically comprise a lift motor driving a cylindrical lift drum. A lift strap is attached to the drum. By rotating the drum, the strap can either wind up or pay out, allowing for the lifting or lowering of patients. On the other hand, floor lifts resemble pneumatic or hydraulic hoists and consist of a lift arm connected to one or more pneumatic or hydraulic cylinders to facilitate patient movement. These lifts are often used for various purposes, including weighing patients who are unable to stand on their own, such as wheelchair-bound individuals or bariatric patients following weight loss surgery.

In certain situations, such as in the event of a failure of a component of the lift system or in unplanned situations, there might be an urgent need to immediately halt the operation of the lift to prevent injury or harm to the patient. While standards require patient lift systems to include an emergency stop system, the existing emergency stop mechanisms of patient lift systems have limited features, are not easily accessible, or may be difficult for caregivers to operate in stressful situations.

Canadian Patent publication no. 2,747,926, for example, discloses an emergency stop system for patient hoists, particularly those mounted on ceiling tracks. It addresses issues with hard-to-reach controls, offering an emergency stop feature that is accessible to caregivers from the floor. The system comprises a switch mechanism that disables the hoist with one motion and re-enables it with another distinct motion to prevent accidental activation.

There is therefore a need for an emergency system for patient lift systems that allows caregivers to quickly and easily halt patient lift operations and proceed to further operations, such as moving up or down the patient in the event of failure. Such a system should be designed for easy engagement and reliable performance to prevent further movement of the lift during an emergency situation, ensuring patient safety.

### SUMMARY OF THE INVENTION

The shortcomings of the prior art are generally mitigated by providing a mechanical apparatus that can immediately halt the movement of the lift when activated. The system comprises an inner body portion slidably inserted in an outer portion. In use, when an emergency occurs, a user pulls on the outer portion which slides in relation to the inner portion. The sliding triggers the stopping the motor of the patient lift.

The outer portion has a diameter or periphery which is larger than the diameter or periphery of the inner portion to allow sliding. As such, the outer portion comprises a hollow portion adapted to slidingly receive the inner portion and a guiding assembly.

The guiding assembly comprises a guiding member to limit the vertical movement of the outer portion in relation to the inner portion. The guiding assembly further comprises a locking assembly. The locking assembly generally allows the outer portion to remained locked to the inner portion 10 when not in used.

In some aspect of the invention, only when the outer portion is slid over the inner portion, an interface to the motor or the patient lift is revealed. In such embodiment, the interface may allow activating the motor in a direction to raise the lift or in another direction to lower the lift

When the stop mechanism is triggered, the electrical connection to the patient lift is turned off or disconnected, preventing further movement.

In one aspect of the invention, an emergency system for patient lifts is provided. The emergency system comprises an inner body portion slidable within an outer body portion, the inner body portion comprising an interface for controlling the patient lift, the outer body portion comprising a retaining member securable with the retaining member of the inner body portion and a retaining assembly to attach the inner body portion to the outer body portion, wherein when the outer body portion is slidden with regard to the inner body portion, the control interface is activated and the patient lift is stopped.

The emergency system may comprise an interrupting assembly adapted to turn off the patient lift when the outer body portion is slidden at a first position with regard to the inner body. The interrupting assembly may be further adapted to activate the control interface when the outer body portion is slidden at a second position with regard to the inner body. The interrupting assembly may comprise a control board comprising two contact regions separated by a non-contacting region and a contacting element adapted to alternatively move over the two spaced-apart contact regions and the non-contacting region, wherein the first contact region enables the patient lift and the second contact region enables the control interface when in contact with the contacting element. The control board may be mounted to the inner body portion and the contacting element being mounted to the outer body portion.

The control interface may comprise a first control to raise the patient lift and a second control to lower the patient lift. The emergency system may comprise a guiding assembly to limit sliding movement of the outer body portion in relation to the inner body portion. Thee guiding assembly may comprise a guiding track and a sliding member moving within the guiding track.

The inner body portion may be resiliently attached to the outer body portion. The retaining assembly may be adapted to detach the inner body portion and the outer body portion upon receiving a predetermined pulling force. The retaining assembly may comprise a male portion operationally connectable with a female portion, the female portion comprising a resilient assembly for retaining the male portion upon receiving the predetermined pulling force.

The inner body portion may enclose the retaining assembly and the outer body portion may enclose the inner body portion.

In another aspect of the invention, a method to perform an emergency stop of a patient lift is provided. The method comprises pulling an outer body portion over an inner body portion at first position to stop the patient lift and pulling the outer body portion over the inner body portion at a second position to uncover and to enable an interface to control the patient lift.

The pulling of the outer body portion at the first position may comprise opening an electrical circuit with the patient lift and the pulling the outer body portion at the second position may comprise closing a control circuit between the patient lift and the control interface.

The method may comprise raising the patient lift using the uncovered interface or lowering the patient lift using the uncovered interface. The method may further comprise locking the outer body portion to the inner body portion when at rest, the pulling of the outer body portion over the inner body portion unlocking the outer body portion from the inner body portion. The method may comprise pulling the outer body portion with a predetermined force to unlock the outer body portion from the inner body portion.

The method may comprise resiliently locking the outer body portion to the inner body portion when the outer body portion is pushed toward the inner body portion. The method may comprise the outer body portion resiliently moving back over the inner body portion when the pulling is released.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an exploded perspective view of an embodiment of an emergency system for patient lifts according to the principles of present invention.

FIG. 2 is perspective view of the emergency system for patient lifts of FIG. 1 shown unused or idling.

FIG. 3 is perspective view of the emergency system for patient lifts of FIG. 1 shown being partially pulled.

FIG. 4 is perspective view of the emergency system for patient lifts of FIG. 1 shown being fully pulled.

FIG. 5 is a front elevation view of the emergency system for patient lifts of FIG. 1.

FIG. 6 is a bottom plan view of the emergency system for patient lifts of FIG. 1.

FIG. 7 is a rear elevation view of the emergency system for patient lifts of FIG. 1.

FIG. 8 is a top plan view of the emergency system for patient lifts of FIG. 1.

FIG. 9 is a perspective vertical sectional view of the emergency system for patient lifts of FIG. 1.

FIG. 10 is a side perspective vertical sectional view of the emergency system for patient lifts of FIG. 1, showing the opposite side of the emergency system of FIG. 9.

FIG. 11 is front perspective view of an embodiment of a holding mechanism for a safety system for patient lifts in accordance with the principles of the present invention.

FIG. 12 is rear perspective view of the guiding assembly of FIG. 11.

FIG. 13 is a side elevation view of an embodiment of an interrupting assembly comprising printed circuit boards in accordance with the principles of the present invention.

FIG. 14 is a front elevation view of the interrupting assembly.

### DETAILED DESCRIPTION OF THE INVENTION

A novel emergency system for patient lifts and method thereof will be described hereinafter. Although the invention is described in terms of specific illustrative embodiments, it is to be understood that the embodiments described herein are by way of example only and that the scope of the invention is not intended to be limited thereby.

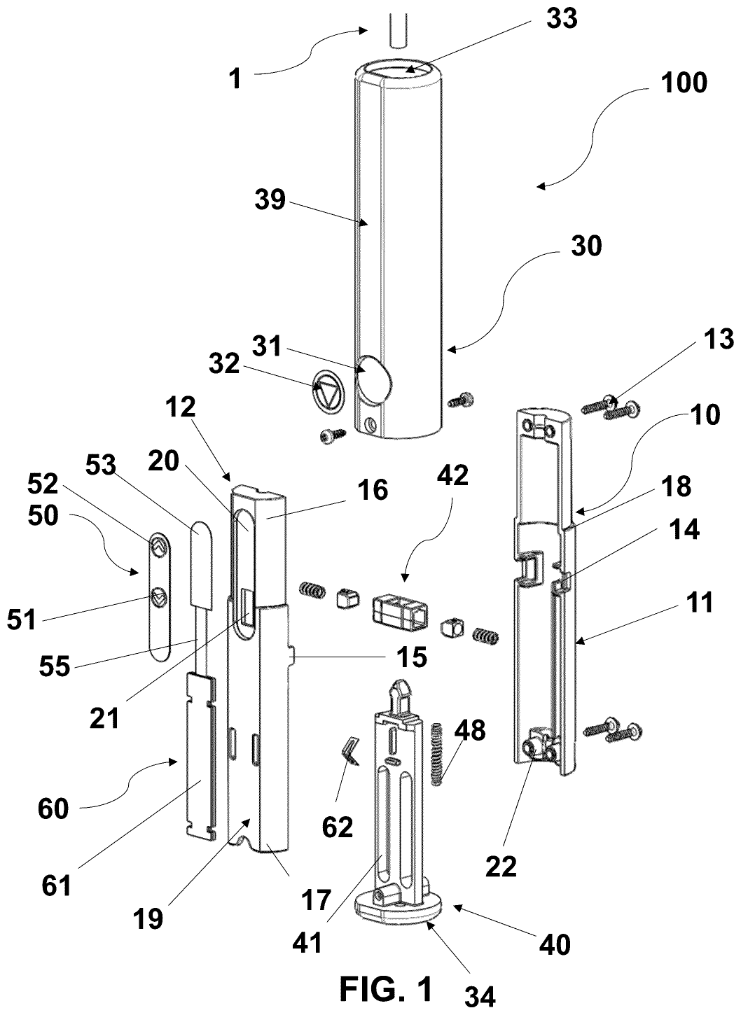

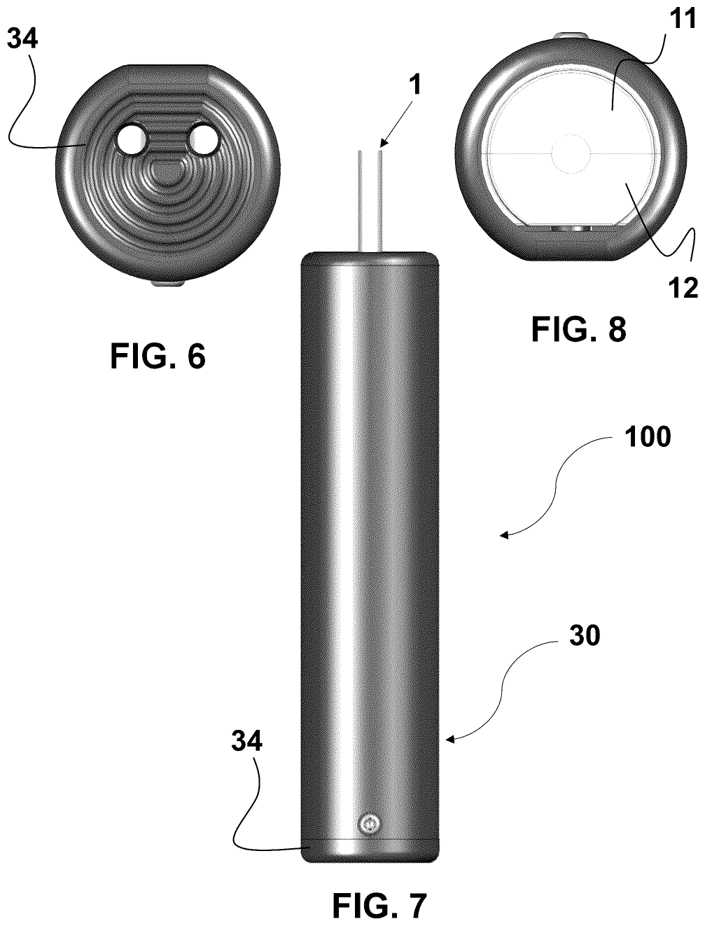

Referring to FIGS. 1-9, an embodiment of an emergency system 100 for patient lifts is illustrated. The system 100 is electrically connected to the motor of the patient lift (not shown) using a cable 1. The system 100 generally comprises an inner body portion 10 slidably inserted in an outer portion 30. In use, when an emergency occurs, a user pulls on the outer portion 30 which slides in relation to the inner portion 10. The sliding triggers the stopping the motor of the patient lift. In some embodiments, only when the outer portion 30 is slid over the inner portion 10, an interface 50 to the motor or the patient lift is revealed.

In yet other embodiment, the interface 50 may be partially revealed or the outer portion 30 may be further pulled as the outer portion 30 is resiliently attached to the inner portion 10. In the illustrated embodiment, the outer portion 30 is spring loaded with regard to the inner portion 10. In such embodiment, the interface 50 may allow activating the motor in a direction to raise the lift or in another direction to lower the lift.

As such, the emergency system 100 may be reactivated by an operator without accessing the patient lift and directly using the system 100. As such, the emergency system 100 is configured to be reactivated by pushing the outer portion 30 over the inner portion 10 and/or the operator may control the lift directly through the interface 50 of the system 100, again without accessing the lift which is located near or at the ceiling level.

Referring now to FIG. 1, an exploded view of the device 100 is shown. In such embodiment, the inner portion 10 comprises a first portion 11 and a second portion 12. The two portions 11 and 12 may each represent a half of the inner portion 10. They may be secured to one another using any type of attachment means, such as fasteners 13. The halves 11 and 12 may comprise matching recesses 14 and protuberances 15. Understandably, in other embodiments, the two halves 11 and 12 may be unitary.

The said recesses 14 and protuberances 15 are used to receive the locking assembly 42 of the outer portion 30. In the illustrated embodiment, both of the halves 11 and 12 comprise an upper 16 and lower 17 portions. The upper portion 16 has a diameter which is smaller than the diameter of the lower portion 17.

The halves 11 or 12 may further comprise a lip or edge 18 at the intersect of the upper portion 16 and lower portion 17. The lip 18 generally allows stopping pulling movement of the outer portion 30.

The second half 12 generally comprises a recess 20 for receiving the interface 50. The recess 20, as illustrated, is shaped to fittingly receive the interface 50. The second half 12 may further comprise an aperture 21 allowing an electrical connection of a contacting element 62 with the contacting plate 61. When the outer portion 30 is slidden over the inner portion 10, the contacting element 62 is moved away from the aperture 21 and stops the motor. The interface 50 is electrically connected to the cable 1. The inner portion 10 may further comprise guiding means 22 adapted to guide the sliding movement of the inner portion 10 in relation to the outer portion 30. In the illustrated embodiment, the guiding means 22 are embodied as matching holes of the halves 11 and 12 for receiving a fastener passing through guiding tracks of the outer portion 30. The guiding mechanism 22 thus limits the vertical movement of the outer portion 30 with regard to the inner portion 10.

The contacting element 62 may be mounted to the outer portion 30 such as being held by protuberances or may be fastened to the outer portion 30 or the guiding assembly 40. In some embodiments, the contacting element 62 may be mounted to a holder (not shown) which is received in a recess portion of the guiding assembly 40. Understandably, any assembly or means to attach or mount the contacting element 62 may be used within the scope of the present invention. As illustrated, the contact element may be a bended plate comprising two contacts. As such when the contact element 62 touches a conductible portion of the printed circuit board 60, an electrical contact is established. In other embodiments, the contact element 62 may comprise three (3) or more contacts and may be shaped differently. Understandably, any contacting element 62 allowing an electrical connection to be established when moving over a conductible portion may be used within the scope of the present invention.

In the illustrated embodiment, the inner 10 and outer 30 portions are generally substantially cylindrically shaped. Understandably, in other embodiments, the inner 10 and outer portions 30 may have different shapes allowing the inner portion 10 to slide and stop in the outer portion 30. As illustrated, the inner 10 and outer 30 portions comprise a flat surface 19 and 39 to receive the interface 50.

The portions 10 and 30 may be made from any rigid materials, such as but not limited to plastic, metal, such as aluminum or stainless steel, to withstand the operational stresses of patient lifts.

The outer portion 30 has a diameter or periphery which is larger than the diameter or periphery of the inner portion 10. The outer portion 30 may comprise a recess 31 or, in other embodiments, an aperture, adapted to receive a plate or sticker to facilitate the understanding by the operator how to manipulate the system 100, such as pulling, of the outer housing 30. The outer portion 30 comprises a hollow portion 33 adapted to slidingly receive the inner portion 10 and the guiding assembly 40.

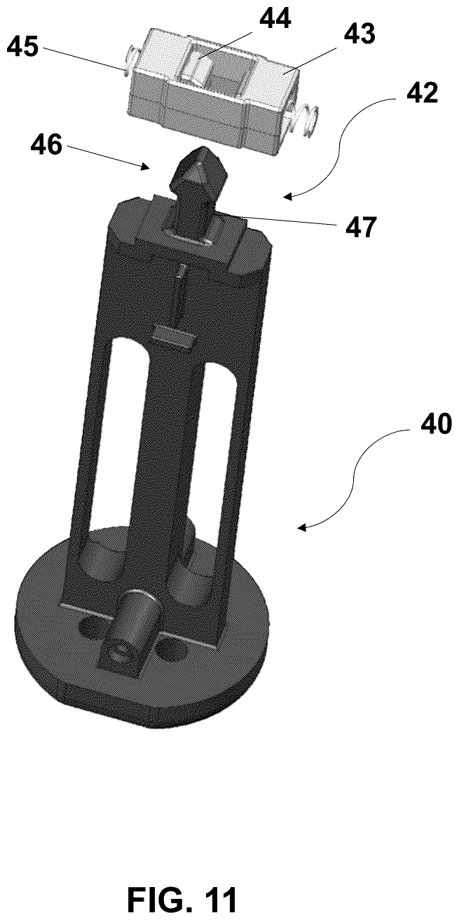

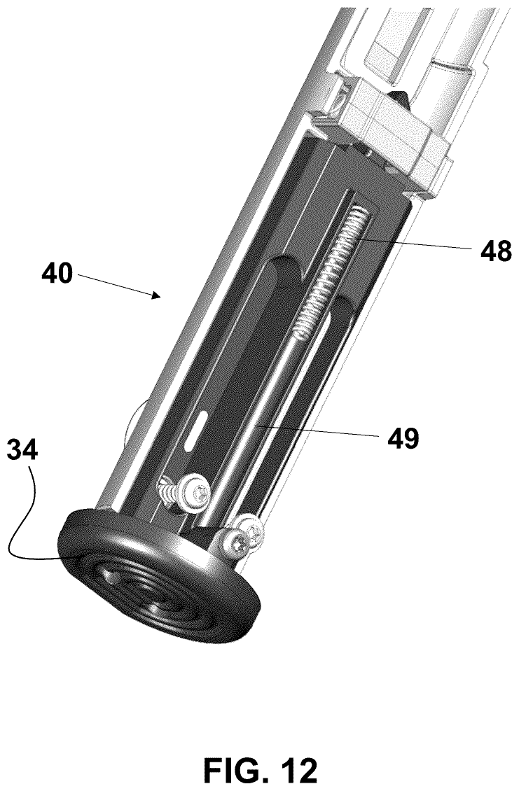

Referring to FIGS. 11 and 12, the guiding assembly 40 comprises a guiding member 41, illustrated as tracks, to limit the vertical movement of the outer portion 30 in relation to the inner portion 10. The guiding assembly 40 further comprises a locking assembly 42. The locking assembly 42 generally allows the outer portion 30 to remained locked to the inner portion 10 when not in used. The locking assembly 42 further requires an initial pulling force to allow sliding movement between the outer portion 30 and the inner portion 10. In the illustrated embodiment, the locking assembly 42 comprises a hollow member 43, pushing members 44, resilient members 45, such as a spring, and a locking head or notch 46. The hollow member 43 is shaped to receive the pushing members and the resilient members 45. The resilient members 45, at one end, push on the inner portion 10, such as on the protuberances 15, an at the other end, on the pushing members 44. The pushing members 44 are thus pushed against one another toward the center of the hollow member 43. When the locking head 46 of the guiding assembly 40 is inserted between the two pushing members, the two pushing members are pushed against a narrow portion 47 of the locking head 46 to lock the said head 46 in place. When a pulling force is applied, the pushing members 44 are pulled away and the locking head 46 is released from the locking assembly 42 to allow lowering the guiding assembly 40.

In the present embodiment, the guiding assembly 40 is attached to the housing of the outer portion 30 using any type of fastener. Understandably, in some embodiment, the guiding assembly 40 and the outer portion 30 may be unitary.

In some embodiment, the guiding assembly 40 may further comprise a resilient member 48, such as a spring, and a cavity or recess 49 matching the shape of the resilient member. The resilient member 49 is attached at one end to the guiding assembly 40 and at another end to the first half 11 of the inner portion 10. As such, when the pulling force is stopped, the outer portion 30 is returned to an intermediate or mid position as the resilient member 48 pulls the outer portion 30. The outer portion 30 may be further pulled to reveal the interface 50 while resiliently returning to the intermediate position if the pulling is stopped. Otherwise, the guiding assembly 40 (and the outer portion 30) remains engaged unless intentionally disengaged by an operator after an emergency stop.

The outer portion may further comprise a base plate 34. In the illustrated embodiment the base plate 34 is integral with the guiding assembly. Understandably, the base plate 34 may be embodied as a separate component.

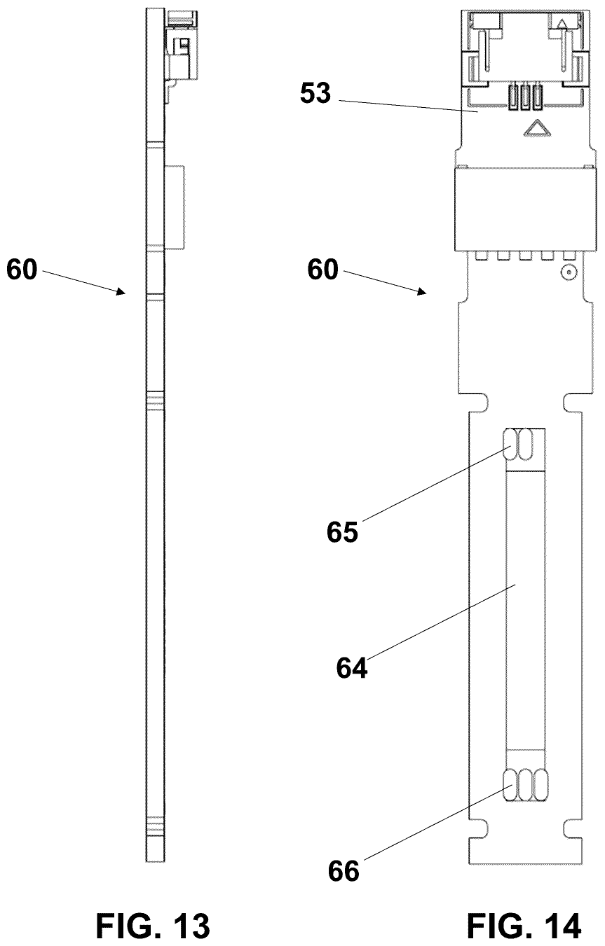

The system 100 further comprises an interrupting assembly 60 adapted to instantly disconnect or stop the patient lift. As such, when the outer portion 30 is pulled, the interrupting assembly 60 is exposed to cut the power of the patient lift. When the outer portion 30 is pulled even more, the circuit powering the patient lift is closed or re-connected to allow moving the patient lift up or down for emergency application. In the illustrated embodiment, the interrupting assembly 60 comprises a printed circuit board 61 attached to the inner body portion. The interrupting assembly 60 further comprises a contacting element 62 frictionally contacting the printed circuit board 61 to close or open an electrical circuit with the patient lift. When the outer portion 30 is pulled, the contacting element or plate 62 is lowered and away from a conductive portion 65 of the printed circuit board 61 toward a non-conductive portion 64 of the printed circuit board 61, thus opening the circuit (see FIGS. 13 and 14). As such, the circuit is only closed when the operator pushed back the guiding assembly 40 in the locking assembly 42.

In some embodiments, the printed circuit board 61 may further comprise a second conductive portion 66. As such, when the outer body portion is further pulled down, the contacting plate 62 may further be moved down from the non-conductive portion 64 toward the second conductive portion 66. The second conductive portion 66 is adapted to power the control interface 50. As such, the control interface 50 is powered only when the outer body portion 30 is pulled enough to uncover the control interface 50 and thus allows the user to raise or lower the lift assembly. The control interface 50 may be electrically connected to a second printed circuit 53, the second printed circuit 53 being in electrical and/or data communication with the patient lift. When the outer body portion 30 returns to an initial position, either by being resiliently pulled or being pushed by the user, the contacting plate 62 moves away from the second conductive portion 66 toward the non-conductive portion 64 and ultimately on the first conductive portion 65. When in contact with the first conductive portion 65, the patient lift is powered and enabled.

In some embodiments, the interrupting assembly 60 may further comprise a second printed circuit board 53.

In the embodiment illustrated at FIG. 1,

In the illustrated embodiments, the first and second printed circuit board 61 and 53 are attached to or supported by to the inner body portion 10. Referring to FIG. 1, the first and second printed circuit boards 61 and 53 may be attached to one another using a flexible cable 55 to power the said boards 61 and 53. The flexible cable 55 is typically narrower than the contacting plates 61 and 53. Understandably, the first and second printed circuit boards 61 and 53 may be connected using any other know method in the art and is not limited to a flexible cable 55.

The system 100 may further comprise an operating interface 50. The interface generally comprises one or more buttons 51, 52 to operate the lift in case of emergency. The interface 50 comprises a circuit board or a contacting means 53 connected directly to the motor of the patient lift, by-passing any controller of the patient lift. As such, when the user pulls the outer portion 30 at a first position and stop the patient lift, the user may, if needed, pull the outer portion 30 further at a second position and hold the pulled outer portion 30. When pulling the outer portion 30 at the second position, buttons 51 or 52 of the interface 50 are revealed or uncovered and may be used to raise or lower the lift by directly controlling the motor. In the illustrated embodiment, the interface 50 may only be operated when the contact plate is in contact with the second conductible portion 66, as explained above. The interface may be connected to the motor through the cable 1, which may be directly connected to the circuit board 53. The cable 1 may be connected to the patient lift using a grommet or any other mechanism increasing the rigidity of the connection. The cable 1 may further be weld to the printed circuit board 60 or may be connected to the printed circuit board 60 using a connector, such as but not limited to a standard connector (as shown at FIG. 14). The grommet may be tapered or shaped as a cone to allow increase rigidity or strength of the cable as the cable may sustain repeated pulling forces when in use.

In some embodiments, in use, when the user fully pulls the outer portion 30, the circuit board 53 of the interface 50 is powered. The circuit board 53 is configured to only trigger specific operations of the patient lift. As such, in the illustrated embodiment, the specific operations are raising and lowering the patient lift in emergency mode. Understandably, in other embodiments, the circuit board 53 may be configured to perform other operations or send requested to the patient lift.

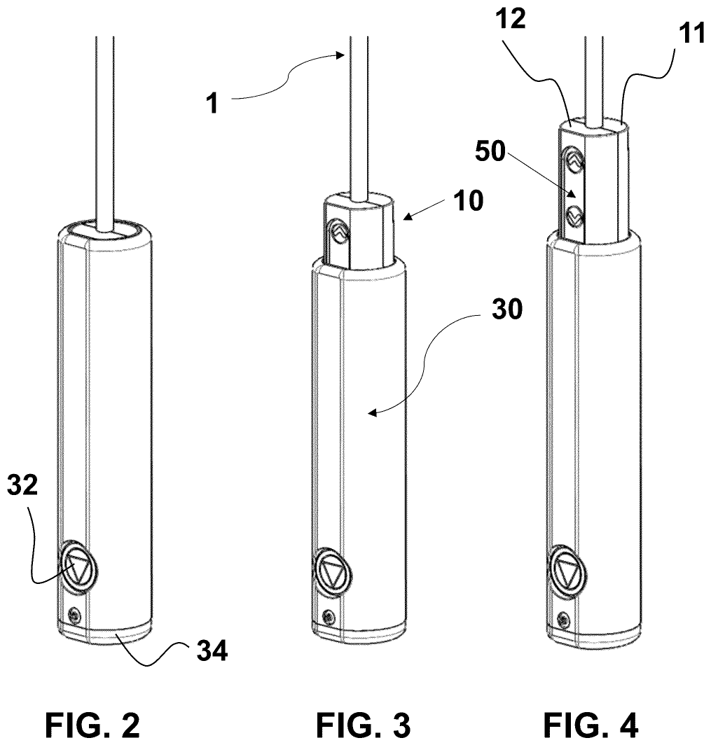

Referring now to FIGS. 2-4, the system 100 is shown in use. At FIG. 2, the device 100 is unused or in idling mode, ready to be used for an emergency stop. At FIG. 3, the operator initiated a pulling movement to activate an emergency mode. As such, the patient lift is disconnected or turned off. In some embodiment, a single button 51 or a portion of the interface 50 may be revealed and at FIG. 4, the operator continued the pulling movement, thus revealing both buttons 51 and 52 and allowing the control of the patient lift in emergency mode.

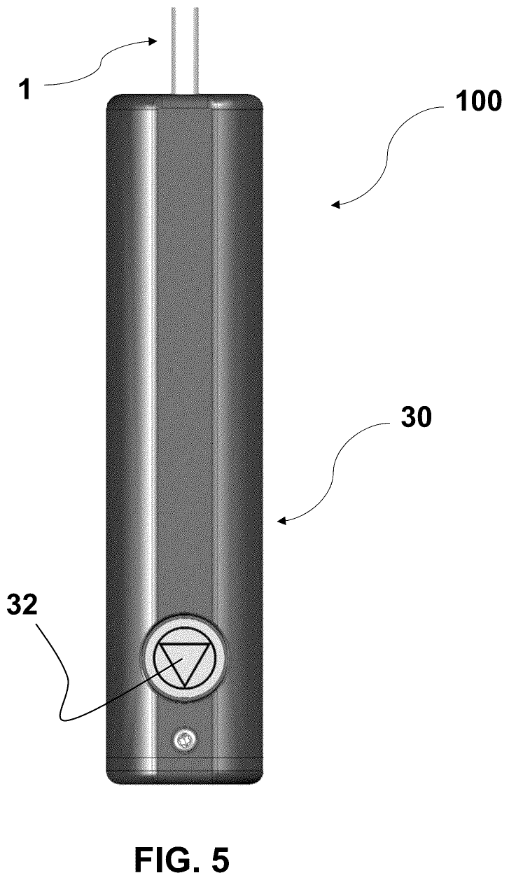

Referring to FIGS. 5-8, an embodiment of the device 100 is shown from front, bottom, rear and top view, respectively. In such embodiment, the outer portion 30 comprises a sign 32 to indicate to the user to pull the device 100 in an emergency event. The sign 32 may be embodied as a sticker or plate being fixed to the outer portion 30. Understandably, any other means to indicate to the user to pull the device may be used within the scope of the present invention.

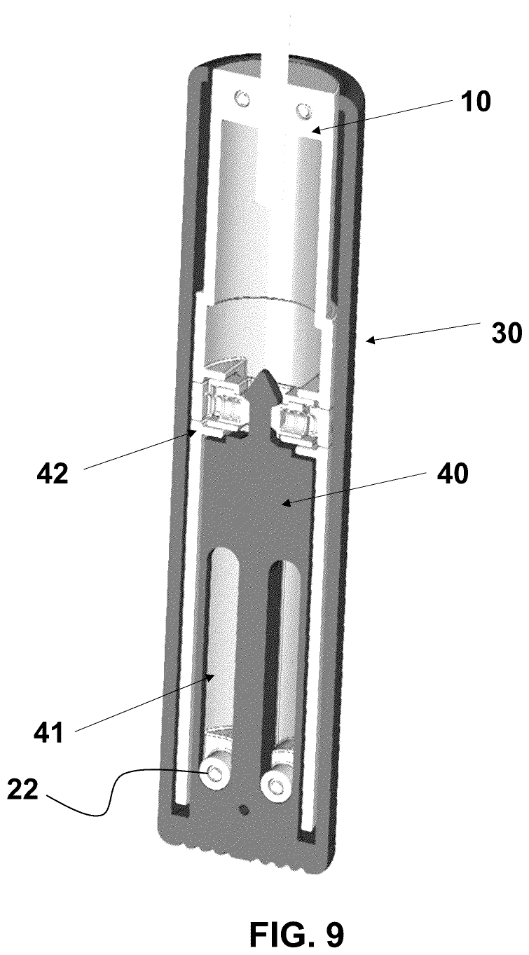

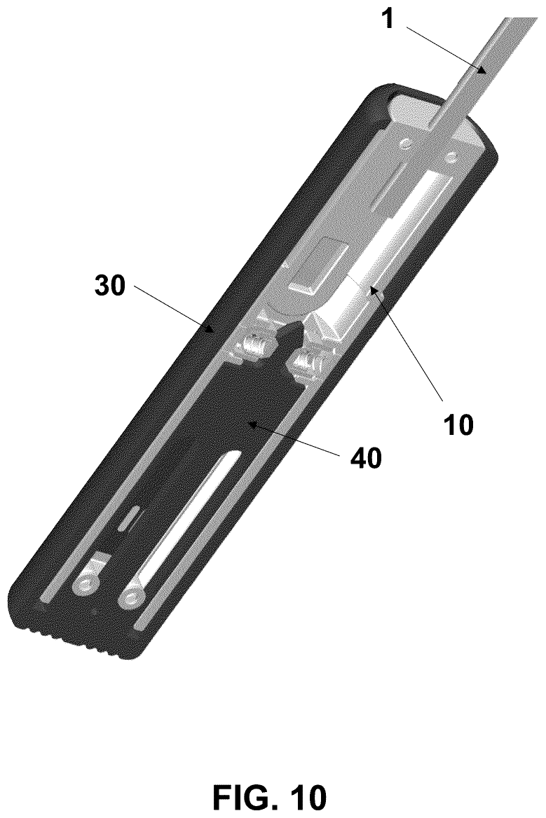

Referring to FIGS. 9 and 10, a section view of the device 100 illustrates the guiding assembly 40 and the locking assembly 42 in a locked position.

A method for operating a patient lift during an emergency stop or failure is provided. During a patient transfer, if the caregiver identifies an emergency, such as patient discomfort, risk of injury, or malfunction of the lift, the operator pulls the outer portion 30 of the system 100. The movement of the outer portion triggers the engaging assembly 42 to be disengaged. Such movement further moves the contacting element 62 away from the contacting plate 61, thus opening the circuit to the patient lift. At such moment, the patient lift is stopped. To enable the patient lift, the outer portion 30 shall be pushed or moved up to re-engage the locking assembly 42 and to move the contact element 62 to contact the contacting plate 61.

In some embodiments, when the outer portion 30 is pulled, a controlling interface 50 is revealed. The controlling interface 50 is a by-pass to the motor of the patient lift, thus allowing moving the patient up or lowering the said patient. Understandably, the pace of movement may be reduced to allow the motor to move the said patient during a failure of the patient lift.

After the emergency situation has been addressed and, if it is safe to resume the operation of the lift, the system can be manually reset by the caregiver. To reset, the caregiver must re-engage the engagement assembly 42 by pushing the outer portion 30. As such, the locking head 46 is locked in place and the circuit is closed by the contacting element 62 contacting the contact plate 61.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An emergency system for patient lifts comprising:
an inner body portion slidable within an outer body portion, the inner body portion comprising an interface for controlling the patient lift, the outer body portion comprising a retaining member securable with the retaining member of the inner body portion; and
a retaining assembly to attach the inner body portion to the outer body portion;
wherein when the outer body portion is slidden with regard to the inner body portion, the control interface is activated and the patient lift is stopped.

2. The emergency system of claim 1 further comprising an interrupting assembly adapted to turn off the patient lift when the outer body portion is slidden at a first position with regard to the inner body.

3. The emergency system of claim 2, the interrupting assembly being further adapted to activate the control interface when the outer body portion is slidden at a second position with regard to the inner body.

4. The emergency system of claim 3, the interrupting assembly comprising:
a control board comprising two contact regions separated by a non-contacting region; and
a contacting element adapted to alternatively move over the two spaced-apart contact regions and the non-contacting region;
wherein the first contact region enables the patient lift and the second contact region enables the control interface when in contact with the contacting element.

5. The emergency system of claim 4, the control board being mounted to the inner body portion and the contacting element being mounted to the outer body portion.

6. The emergency system of claim 1, the control interface comprising a first control to raise the patient lift and a second control to lower the patient lift.

7. The emergency system of claim 1 comprising a guiding assembly to limit sliding movement of the outer body portion in relation to the inner body portion.

8. The emergency system of claim 7, the guiding assembly comprising a guiding track and a sliding member moving within the guiding track.

9. The emergency system of claim 1, the inner body portion being resiliently attached to the outer body portion.

10. The emergency system of claim 1, the retaining assembly being adapted to detach the inner body portion and the outer body portion upon receiving a predetermined pulling force.

11. The emergency system of claim 10, the retaining assembly comprising a male portion operationally connectable with a female portion, the female portion comprising a resilient assembly for retaining the male portion upon receiving the predetermined pulling force.

12. The emergency system of claim 1, the inner body portion enclosing the retaining assembly and the outer body portion enclosing the inner body portion.

13. A method to perform an emergency stop of a patient lift comprising:
pulling an outer body portion over an inner body portion at first position to stop the patient lift; and
pulling the outer body portion over the inner body portion at a second position to uncover and to enable an interface to control the patient lift.

14. The method of claim 13, the pulling of the outer body portion at the first position opening an electrical circuit with the patient lift and the pulling the outer body portion at the second position closing a control circuit between the patient lift and the control interface.

15. The method of claim 13 further comprising:
raising the patient lift using the uncovered interface; or
lowering the patient lift using the uncovered interface.

16. The method of claim 13 further comprising locking the outer body portion to the inner body portion when at rest, the pulling of the outer body portion over the inner body portion unlocking the outer body portion from the inner body portion.

17. The method of claim 16 further comprising pulling the outer body portion with a predetermined force to unlock the outer body portion from the inner body portion.

18. The method of claim 17 further comprising resiliently locking the outer body portion to the inner body portion when the outer body portion is pushed toward the inner body portion.

19. The method of claim 13 further comprising the outer body portion resiliently moving back over the inner body portion when the pulling is released.
